(19) United States
(12) Patent Application Publication
(10) Pub. No.: US 2012/0063737 A1
(43) Pub. Date: Mar. 15, 2012

(54) VEHICLE-MOUNTED VIDEO SURVEILLANCE SYSTEM

(76) Inventor: Maurice J. Gregoire, Brampton (CA)

(21) Appl. No.: 13/049,273

(22) Filed: Mar. 16, 2011

Related U.S. Application Data
(60) Provisional application No. 61/314,810, filed on Mar. 17, 2010.

(51) Int. Cl. H04N 5/77

(52) U.S. Cl. 386/224; 386/E05.069

(57) ABSTRACT

A system is disclosed to record traffic infractions in the general area of a school bus and its stop arm, consisting of two cameras, a first camera which produces a general overview of the area, and a second camera which produces a focused view of a license plate, both within a housing. The housing consists of a weather-sealed camera housing with lenses, and a mounting plate, where the mounting plate mounts to the side of a bus, near the stop arm, and is so directed to capture video images of vehicles coming toward the bus. The weather-proof enclosure contains two cameras, one which captures the general overview, and a high-definition camera which captures the license plate details of passing vehicles. The data from the two cameras is sent to a digital video recorder inside the school bus. Information from a GPS module mounted on the bus is also sent to the recorder to be recorded alongside the video images.

### CROSS-REFERENCE TO RELATED APPLICATIONS

This application claims the benefit of U.S. provisional patent application Ser. No. 61/314,810, filed on Mar. 17, 2010, all of which is incorporated by reference as if completely written herein.

### STATEMENT REGARDING FEDERALLY SPONSORED RESEARCH OR DEVELOPMENT

Not applicable.

### TECHNICAL FIELD

The present invention relates generally to the field of video recording systems and specifically to vehicle-mounted video surveillance systems.

### BACKGROUND OF THE INVENTION

School buses have stop-arms which extend from the side of the bus while it is stopped, which stop signs signal to drivers that they are not to pass the bus from either side. This is to prevent a driver from hitting children or caregivers which are present around the bus while it is stopped.

Despite serious fines and other punishment that may be imposed on cars that do not obey the signals, some cars recklessly pass the bus while it is stopped. In order to prevent this, police and other law enforcement attempt to impose the sanctions, but cannot always be present to sanction a perpetrator.

In order to record activity in particular locations, various camera systems employing motion sensitivity have been proposed in the prior art. For example, in U.S. Pat. No. 5,602,585 (Dickinson) a motion detection camera system takes photos periodically, determining if differences occur between frames, in which case motion has occurred and the camera starts normal motion capture. In U.S. Pat. No. 4,651,144 (Pagano) a camera housing containing a dummy camera, with a motion detector attached is disclosed, which housing changes appearance on detection of motion, so as to appear that it is recording.

In U.S. Pat. No. 6,121,898 (Moetteli), a traffic law enforcement system is disclosed which, using two license-plate readers, calculates the average velocity of a vehicle of a distance so as to determine whether the vehicle has been speeding. In U.S. Pat. No. 5,734,337 (Kupersmit) a method for determining the speed of a vehicle using a camera is disclosed.

In the prior art there are patents directed to improving the safety of the school bus stop arm by video recordation of traffic on both sides of the stop arm. For instance, in U.S. Pat. No. 6,738,089 (Silc) a camera unit is mounted on the bus above the stop arm, and it simultaneously records video images of both front and rear views vis-à-vis the stop arm using a prism. The image, in addition to being recorded, is sent to the driver inside the bus. However, license plate data is not captured due to limited image resolution, and the camera mounting system and prism are not conducive to proper sighting.

In another U.S. Pat. No. 5,793,420 (Schmidt), at least three video cameras are used, two on the outside of the bus and one within it. When the bus' flashing system is activated, the video signals are captured by the cameras mounted externally and relayed inside the school bus for viewing by the driver. This camera system again is not designed to capture the license plate image, it is difficult to install and the connection of the camera to the stop sign increases the vibration and wear and tear on the camera.

Accordingly, there is a need for a camera system that is able to record the details of activity of motorists with regard to buses using flashing stop-arms. In particular, capturing the license plate information effectively can lead to the camera being useful for traffic enforcement and evidence in cases in which it is required.

### SUMMARY OF THE INVENTION

A system is disclosed to record traffic infractions in the general area of a school bus and its stop arm, consisting of two cameras, a first camera which produces a general overview of the area, and a second camera which produces a focused view of a license plate, both within the housing. The housing consists of a weather-sealed camera housing with lenses, sealingly affixed to a mounting plate with a compressed rubber gasket disposed in between, where the housing and mounting plate assembly is affixed to the side of a bus, near the stop arm, and is so directed to capture video images of vehicles coming toward the bus. The weather-proof enclosure contains two cameras, one which captures the general overview, and a high-definition camera which captures the license plate details of passing vehicles. The data from the two cameras is sent to a digital video recorder inside the school bus. Information from a GPS module mounted on the bus is also sent to the recorder to be recorded alongside the video images. In another embodiment, an interior camera is present to capture video of activity within the bus, which is then provided to a second digital video recorder module. The first and second DVR modules may have security features, both physical and electronic, such that each may only be accessible by a different organization.

### BRIEF DESCRIPTION OF THE DRAWINGS

Without limiting the scope of the vehicle-mounted video surveillance system as claimed below and referring now to the drawings and figures:

FIG. 1 is a symbolic view of the system, according to one embodiment of the present invention;

FIG. 2 is a front perspective view of the assembled housing, according to one embodiment of the present invention;

FIG. 3 is a perspective view of the camera mounting plate, according to one embodiment of the present invention;

FIG. 4 is a rear perspective view of the assembled camera housing, according to one embodiment of the present invention;

FIG. 5 is a perspective view of the dual digital video recorder module, according to one embodiment of the present invention; and

FIG. 6 is a perspective view of the assembled housing, having a teardrop housing window, according to another embodiment of the present invention.

These drawings are provided to assist in the understanding of the exemplary embodiments of the vehicle-mounted video surveillance system as described in more detail below and should not be construed as unduly limiting the device. In particular, the relative spacing, positioning, sizing and dimensions of the various elements illustrated in the drawings are not drawn to scale and may have been exaggerated, reduced or otherwise modified for the purpose of improved clarity. Those of ordinary skill in the art will also appreciate that a range of alternative configurations have been omitted simply to improve the clarity and reduce the number of drawings.

### DETAILED DESCRIPTION OF THE INVENTION

The present invention will now be described more fully hereinafter with reference to the accompanying drawings, in which preferred and other embodiments of the invention are shown. No embodiment described below limits any claimed invention and any claimed invention may cover processes or apparatuses that are not described below. The claimed inventions are not limited to apparatuses or processes having all the features of any one apparatus or process described below or to features common to multiple or all of the apparatuses described below. It is possible that an apparatus or process described below is not an embodiment of any claimed invention. The applicants, inventors or owners reserve all rights that they may have in any invention claimed in this document, for example the right to claim such an invention in a continuing application and do not intend to abandon, disclaim or dedicate to the public any such invention by its disclosure in this document.

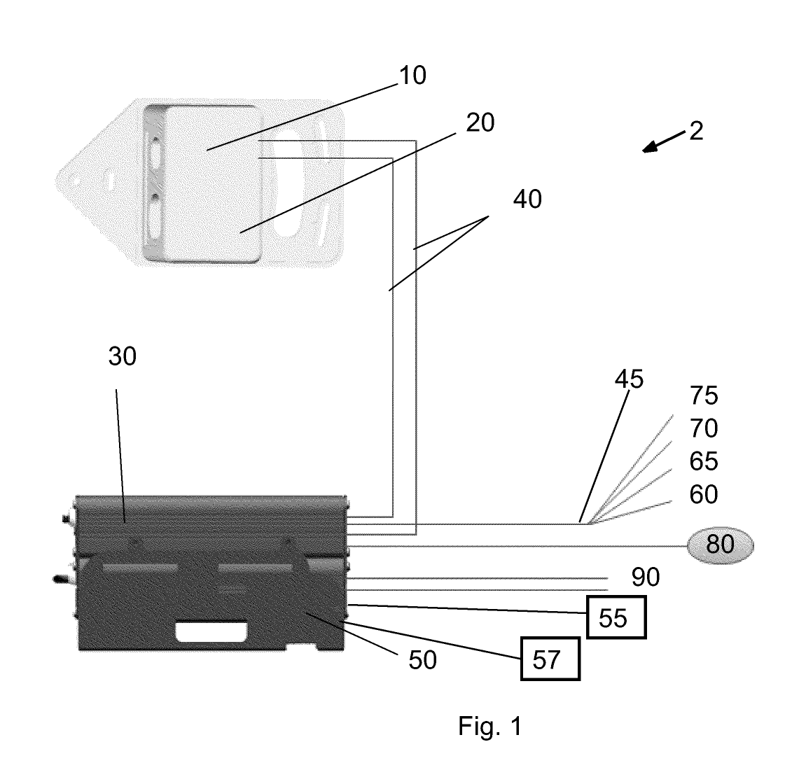

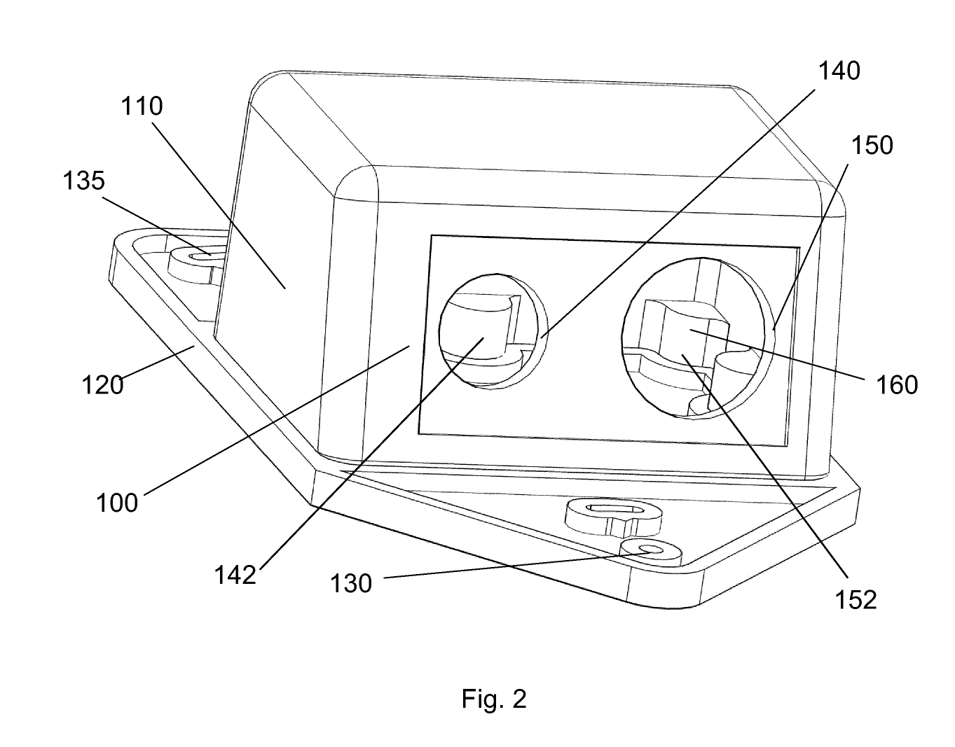

With reference to FIG. 1 and according to one embodiment of the present invention, the vehicle-mounted video surveillance system 2 works by use of two digital video cameras, a first general overview camera 10, and a second detail view camera 20, which capture video images, and transmit same to a digital video recorder (“DVR”). The general overview camera 10 is, in one embodiment, a 3.6 mm lens CCD NTSC board camera, preferably with automatic picture correction technology, that will be used to capture a general overview of an infraction. The camera will record the context around the vehicle, the approach and exit of the vehicle causing the infraction and its behavior. The detail view camera 20 is, in one embodiment, a 12 mm to 25 mm lens high-definition CCD NTSC board camera with automatic picture correction technology, that is used to capture the actual license plate of the vehicle causing the infraction. Both cameras 10, 20 are passive, continuous display cameras with no moving parts, and are enclosed within the housing 110 (shown in FIG. 2 only). In another embodiment both cameras 10, 20 may be present on one board. Once video data is captured by the first and second cameras 10, 20, the data is sent to a central DVR module 30 by means of cables 40 and stored on a memory card (not shown), such as an SD card, for later removal and processing. The camera output may be a digital signal, wherein a digital signal would be sent by cable 40 to the DVR module 30, or the camera output may be analog, wherein an analog signal is sent to the DVR module 30, which then converts the analog signal to a digital signal. The DVR module 30 is housed in a shock-proof bracket 50. A battery 55 is present on the main circuit board (not shown) of the DVR module 30 to retain the DVR 30 settings; this addition is critical to retain all the DVR settings for an extended power-down situation. The battery 55 may be affixed to the main board (not shown) using an anti-vibration connector (not shown) such as a rubber insulator. The DVR module is also connected by electrical cable to the bus 12-volt power system 60, the amber light switch signal 65, the stop-arm switch 70, and the bus key switch on 75. The DVR module 30 is also connected to the signal from a passive global positioning system (GPS) module 80, which relays the present position of the bus, as well as to the on-board bus cameras 90, which provides footage of the interior of the bus.

In yet other embodiments, the DVR module may be enabled or disabled by either a wired or wireless remote control 45. Having control of the system remotely offers greater access security and prevents unauthorized access to the DVR settings and image data. Any electrical or signal interconnections may be used in the invention as remain within the scope of the invention, however a preferable may be aviation-type connectors or BNC connectors, both well known in the art, or for freedom of interconnection between the two types of connectors, an Aviation-to-BNC adapter is available.

The DVR module 30 may have installed within its firmware a feature of adjustable pre- and post-recording; this allows the DVR module 30 to start recording before the event actually took place. As this is a digital recording device the DVR module 30 can be set to start recording the video based on buffer memory before an event occurs. The DVR module 30 may continue to record after the event has passed using a simple event timer countdown. In one embodiment the DVR module 30 has further attached to it a motion detector 57 or other sensor for light or sound which sensor provides a signal to commence the recording process to the DVR module 30.

The system does not share any resources with the bus except the bus 12-volt power system 60 run through the bus run/aux key switch 75. Connection to the amber light switch signal 65 permits the DVR module 30 to be set up to start recording only when the amber flashers (not shown) are operating and the stop-arm (not shown) is lowered. This selective recording would alleviate privacy concerns. The DVR module 30 will record all video, GPS location information, vehicle identification footage, time and date information onto the solid-state SD (secure digital) memory card. The data contained on the SD card is later processed at a secure facility, and the data is kept confidential in transit to the proper authorities. If there is no data of interest on the SD card, it is erased conforming to regional privacy law. The DVR module 30, in other embodiments, may be designed to record the high-definition license plate video onto a memory card (not shown) at D1 video resolution, while the general-overview video footage is recorded onto a removable hard drive. The DVR module 30 is rated for extreme environment operation, for temperatures in the range of −40° C. to 70° C., and for a 300 g-force impact as a result of being mounted within a shock-proof bracket (not shown), and is protected from unauthorized access by means of a lockable steel or polycarbonate security cover plate (not shown).

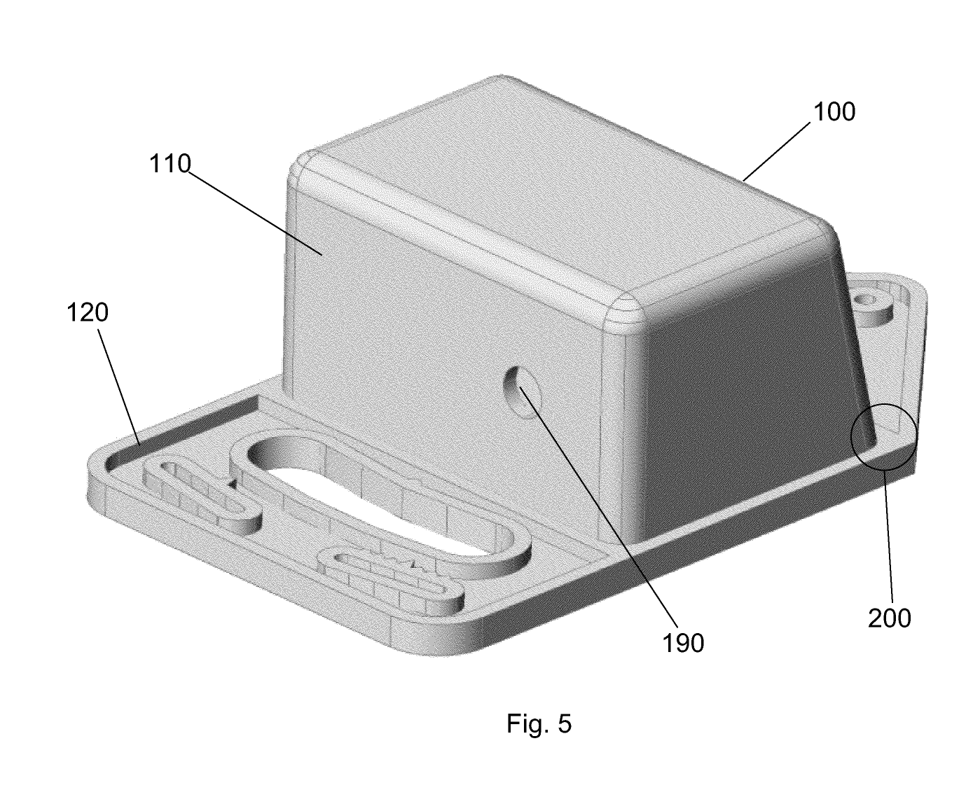

In yet another embodiment, a third camera for monitoring the interior of the bus is mounted to the front interior wall of the bus, and captures video footage of the activity inside the bus. This third camera provides video data to the DVR module 30 which is also recorded on an SD card (not shown). In this embodiment, a dual DVR module is used, described further in the description of FIG. 5, below. This dual DVR system replaces the DVR module 30 in the schematic of FIG. 1, and consists of a first high definition DVR for stop arm video license plate and general overview capture and a second general purpose DVR for recording the data from the third camera, which shows activity inside the bus. The first high definition DVR embeds associated positional (latitude and longitude) and velocity information directly into the video. Both the first high definition and the second general purpose DVR modules are contained within a single housing and are both powered by means of bus power and do not share any resources with each other. Each of the DVR modules is secure and accessible by a different organization, so that privacy concerns are alleviated. The DVRs may record data on memory cards or optionally on a removable hard drive, within a secured location and incorporating a mechanism for encrypting and securitizing the data thereon.

The DVR module may further contain, or be attached to, a serial or Ethernet port, or other network access such as 3G, which connection would be secure and accessible only for authorized users, for access to the recorded video by laptop computer. The DVRs may also have a memory-card slot for alternate recording means or for firmware upgrades. The DVR module activity lights (standby, recording, power, activity) may be present in the driver's console, so that the bus driver may be responsible for the proper operation of the DVR module 30.

With reference to FIG. 2 and according to one embodiment of the present invention, the camera housing 110, having the shape of a hollow truncated pyramid and having a front face 100 is shown sealingly attached to the mounting plate 120, by means of screws (not shown) and a sealing gasket (not shown) disposed between the camera housing 110 and mounting plate 120. The mounting plate 120 is mounted to the vehicle by means of screws (not shown) through the fixed mounting hole 130 and adjustable mounting holes 135. The housing 110 forms approximately a truncated pyramidal shape with rounded corners, wherein the bottom end of the truncated pyramid is open. The interior (not shown) of the housing 110 contains mounting points for two cameras 10, 20. The housing 110 has two openings for cameras 10, 20 in its front face 100, that is, a smaller first opening 140 for a general overview camera 10 (not shown) and a second larger opening 150 for a detail view camera 20 (not shown). The openings are filled with a smaller lens 142 and a larger lens 152 of shatter-resistant glass or polycarbonate plastic, and with O-rings (not shown) or caulking to seal the lens into the housing 110. In one embodiment, the lenses are composed of 4 mm glass coated with a self-cleaning coating, well known in the art. In another embodiment, the openings 140, 150 have a lip (not shown) on the outer perimeter such that lenses 142, 152 may be mounted from the inside for ease of manufacture. Within the housing 110, and molded as part if the housing 110, are camera mounts 160, for use in mounting said first and second cameras (not shown). The housing 110 is provided with rounded corners to reduce injury, and may be painted school bus yellow to match the bus. The housing 110 and mounting plate 120 may be manufactured from 4 mm polycarbonate plastic for durability, waterproofing and low cost of manufacture. Other types of plastic which are waterproof and impact-resistant would be known to one skilled in the art, and could be substituted for polycarbonate, while remaining within the scope of the invention.

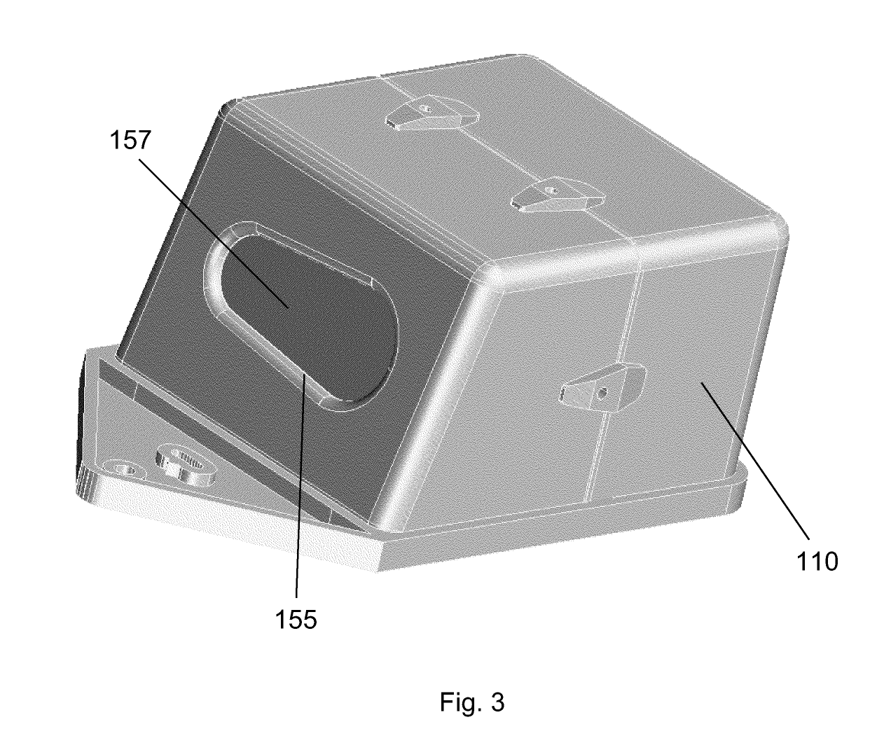

With reference to FIG. 3, another embodiment of the housing 110 is shown, having a teardrop-shaped opening 155, which is filled with a teardrop-shaped lens 157 replacing the first and second openings 140, 150 and lenses 142, 152 referred to above. The teardrop-shaped lens 157 allows for easier cleaning of the window for improved camera visibility throughout the field of view. The lens 157 may be secured within the opening 155 by means of a silicone-based gasket, or other sealing means which are well-known in the art. The housing 110 in this embodiment is reversible and may be used equally right-side up or upside down.

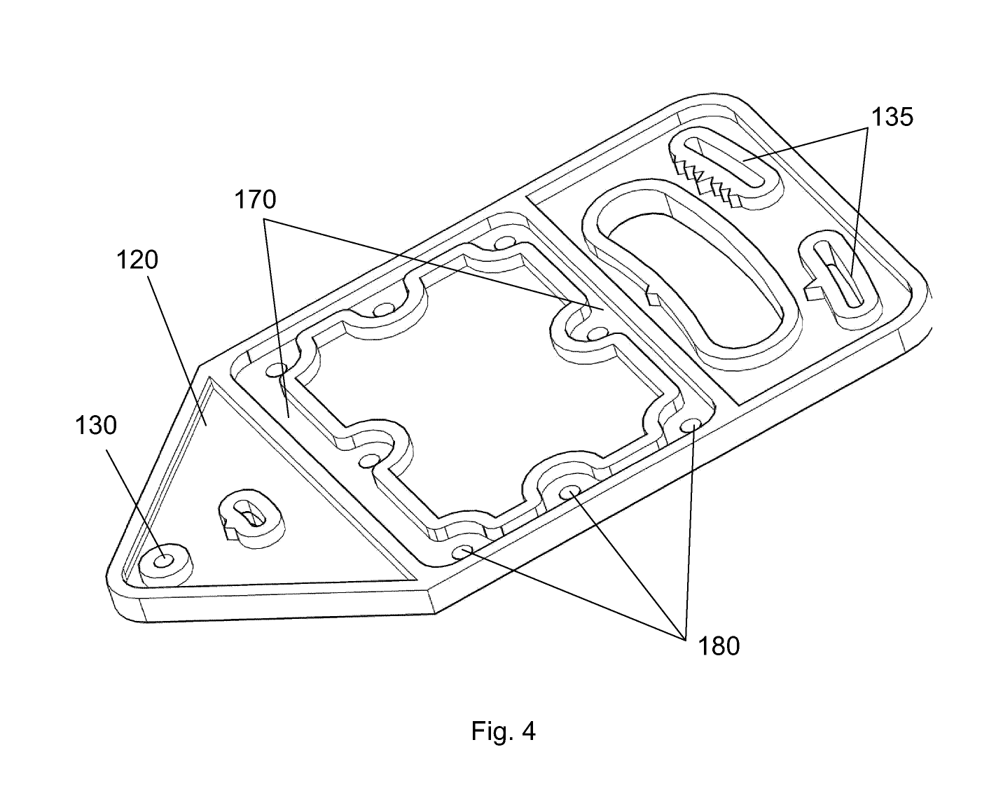

With reference to FIG. 4 and according to one embodiment of the present invention, the mounting plate 120, preferably made from one piece of polycarbonate plastic, is shown. The camera housing 110 (not shown), preferably made of one piece of polycarbonate plastic, fits within the housing groove 170, which contains a rubber gasket (not shown) at the time it is joined with camera housing 110 in order to seal out the elements. The camera housing 110 (not shown) is secured to the mounting plate 120 using bolts (not shown) through mounting holes 180. The assembled camera housing 110 (not shown) and mounting plate 120 combination is mounted to the side of the school bus by means of the fixed mounting hole 130 and adjustable mounting holes 135. First, an orientation for the camera mounting is determined, and a screw (not shown) is placed through the mounting hole 130 into the bus side, sufficiently loosely to permit pivoting of the mounting plate 120 around the rest of the mounting plate 120. The mounting plate 120 is then pivoted around mounting hole 130, potentially to the extent permitted by the adjustable mounting holes 135, in order to find a precise position for optimal license-plate capture. The angle of the camera is then adjusted for the best viewing angle of the cameras by turning the cameras on and viewing the camera view through a screen within the bus. Once the best angle is chosen, all screws (not shown) are fixed tightly through the mounting plate 120 and into the bus.

With reference to FIG. 5 and according to one embodiment of the present invention, the cable hole 190 permits a cable to exit the housing 110 and connect the general overview and detail view cameras 10, 20 (not shown) within to the DVR module within the school bus (not shown). The cable hole 190 is approximately 20 mm in diameter, in one embodiment, and will accommodate a threaded cable compression attached to secure and waterproof the cable hole 190. The cable passing through the cable hole 190 is preferably sealed within the cable hole 190 against the elements by means of silicone caulking Preferably, the entire housing is sealed, so that moisture may not enter the interior and affect the electronic circuits (not shown) of the cameras 10, 20 (not shown) inside. Cables may be connected with compression connectors which permit cable replacement without need to open the housing 110. In another embodiment, a cable cover housing may be added to protect the cable connections, the cover being a piece of plastic well-known in the art to shield the entry point of the cable into the housing, the cable hole 190.

As seen in FIG. 5, in one embodiment the front face 100 forms preferably a 102°-108° angle with the mounting plate 120 at reference point 200, to best capture a license plate and the general overview. However the invention may have an angle between 95° and 135° and still provide the ability to accurately capture the license plate. The corresponding angle inside the housing 110 would therefore be between 85° and 45°. Such an angle increases aerodynamics and reduces drag on the vehicle to which the housing 110 is mounted, improving fuel economy. An angle in this range also allows the cameras 10, 20 the ideal field of vision; furthermore, the fixed angle allows easier installation and reduces target sighting at installation. In other embodiments, the angle may vary widely depending on the mounting point, however, and will always be positioned so as to best capture a clear view of a license plate.

According to one embodiment of the present invention, the general overview camera 10 constantly takes video of the larger situation in front of the camera, including the presence of the stop-arm, and will show the vehicle entering the vicinity, passing by and leaving the vicinity of the stop-bar. The general overview camera 10 shows the type and colour of vehicle, and may be able to show the driver's activities, depending on the light and angle. The detail view camera 20 sees the same view as the general overview camera 10, however with its high-definition resolution is focused in to the area through which the vehicle's license plate will pass, so that the license plate is stored and may be retrieved in the case that it is required by police, for instance. Both cameras 10, 20 are contained in the housing, are sighted to a common point to preserve the integrity of the evidence, and send their respective video data to the DVR module 30. The DVR module 30 also receives a signal from the GPS module 80, which will associate the location and velocity of the school bus (not shown) to the video data. This data is all recorded on a portable memory card (not shown) for later removal, analysis and archiving.

The vehicle-mounted video surveillance system may be used in applications apart from the school bus application described herein, without deviating from the scope of the invention. For instance, such a system may be used around sanitation vehicles to ensure the employees' behavior.

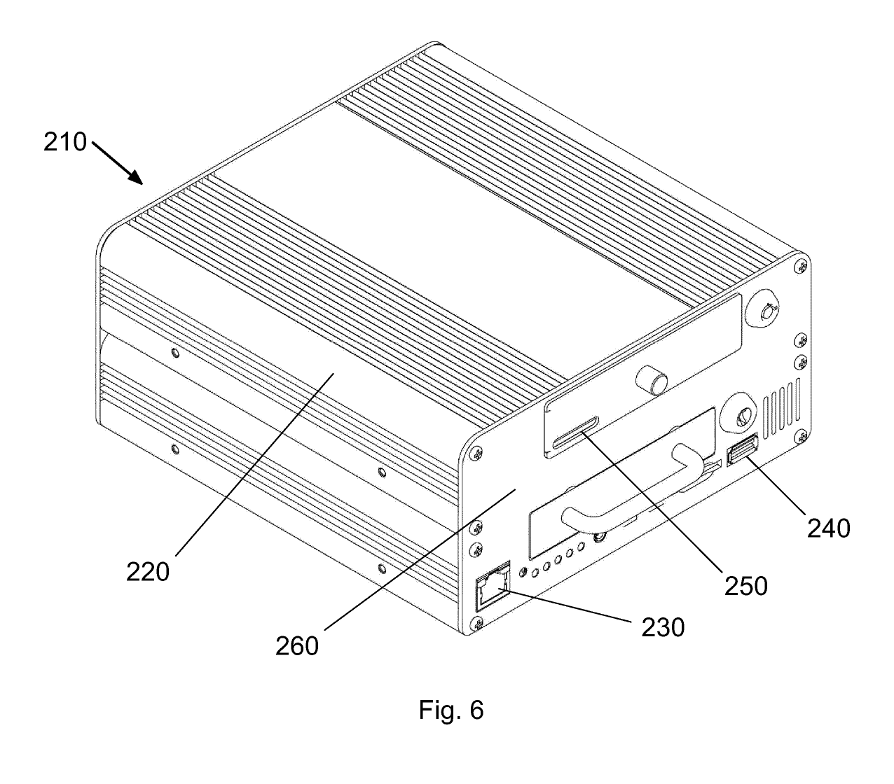

In FIG. 6, and according to one embodiment of the invention, a dual DVR module 210 is shown. This dual DVR module 210 replaces the DVR module 30 in the schematic of FIG. 1, and consists of a first high definition DVR for stop arm video license plate and general overview capture and a second general purpose DVR for recording the data from the third camera, showing activity inside the bus. The first high definition and second general purpose DVRs may store data on recording media such as memory cards and hard drive units, which recording media may be secured both physically by means of lockable cover plates, and electronically by means of data access restrictions like passwords and encryption, and are selectively and separately accessible by those who are granted authorization. These two DVR modules are contained within a single housing 220 and are both powered by means of bus power and do not share any resources with each other. The dual DVR unit may be interfaced with by means of Ethernet port 230 or a USB (serial) port 240. The front 260 of the DVR module 210 contains a memory card slot 250 as well. Each of the DVR modules may be made secure and accessible by a different organization, both physically by means of lockable plates, and electronically, so that the data is encrypted and access requires a password, so that privacy concerns are alleviated.

In another embodiment, the dual DVR module 210 contains two individual DVR units, each with its own targeted functions of use: a first memory-card based DVR unit specifically designed for recording in a high definition format for the capture of license plate images; and a second, memory-card and hard-drive-based DVR unit for the general overview, the two DVR units sharing the same CPU engine.

A PC client program is used to view the video and manage the capture of the still images. The PC Client has many special features that facilitate use of the dual DVR module 210 in particular, however, these features apply to the DVR module 30 and dual DVR module 210. A slider bar is provided that will give the user the ability to slide the video back and forth to find the exact frame to capture. This is done while watching the recorded video. The user clicks and holds the mouse button while on the slider bar and moves the mouse left or right to access the specific video frame required. A single frame capture feature can save a frame of the video as an image in a .BMP or .JPG format, which image contains all the vehicle telemetry and the Google™ map information, for example speed, direction, time, date, vehicle identification, route, sensor inputs, and synchronized map location, among other data. A reverse frame feature allows for a frame by frame stepping in reverse to attain the exact frame required. This is a more precise alternative for the slider bar. Event listing and individual event conversion to .AVI allows the user to select any event and export it to a .AVI formatted video for standard viewing and sharing. This feature is important for selecting the infraction event for distribution. Further, a sizable maps feature allows the Google™ map to be resized and zoomed in or out, which feature is particularly useful for rural infractions.

Many modifications and other embodiments of the invention will come to the mind of a person skilled in the art having the benefit of the teachings presented in the foregoing description and associated drawings. Therefore, it is understood that the invention is not to be limited to the specific embodiment disclosed, and that modifications and embodiments are intended to be included within the scope of the appended claims.

I claim:

1. A vehicle-mounted video surveillance system comprising:
a) a mounting plate having mounting holes;
b) a camera housing formed of plastic and in the shape of a hollow truncated pyramid, having one or more openings in a front face of said housing, each opening having a corresponding lens sealed therein;
c) a general overview camera;
d) a high-resolution detail view camera; and
e) a digital video recorder module positioned within a vehicle; and
wherein said general overview camera and said detail view camera are mounted within said camera housing and are connected to said digital video recorder, which digital recorder is capable of recording video data provided by said cameras, said camera housing sealingly attached to said mounting plate, the front of the housing having an angle of between 95° and 135° with the mounting plate, and said mounting plate is affixed to the vehicle.

2. The system of claim 1, wherein the combination of the mounting plate and the camera housing are oriented to see passing traffic.

3. The system of claim 1, wherein the digital video recorder module is connected to a bus power system and stop-arm switch.

4. The system of claim 3, wherein the digital video recorder module is activated by the stop-arm switch.

5. The system of claim 1, the digital video recorder module further comprising a battery for retaining all settings for an extended power-down situation.

6. The system of claim 1, wherein the digital video recorder module may be enabled or disabled by remote control.

7. The system of claim 1, wherein the digital video recorder module has adjustable pre-recording and post-recording.

8. The system of claim 1, wherein the housing has one opening and said opening and corresponding lens are in a teardrop shape.

9. The system of claim 1, wherein the digital video recorder is mounted within a shock-proof bracket which bracket has a lockable security cover plate.

10. The system of claim 1, wherein the digital video recorder is capable of writing data to a recording medium.

11. The system of claim 1, wherein the vehicle is a school bus.

12. The system of claim 1, further comprising a global positioning system module, wherein said global positioning system module is connected to said digital video recorder, which digital recorder is also capable of recording position data provided by said global positioning system module.

13. The system of claim 1 further comprising a first and a second lens, wherein said camera housing has a front which has a first and a second opening, which first opening contains a first lens and which second opening contains a second lens, which lenses are sealingly engaged within said openings.

14. The system of claim 1, further comprising a gasket compressed between said camera housing and said mounting plate.

15. The system of claim 1, further comprising an interior camera positioned within the bus and adapted to capture video images of activity within the bus; and a second digital video recorder positioned within said vehicle, which said second digital video recorder is capable of recording video data provided by said interior camera.

16. A housing for a camera adapted to be mounted on a vehicle, comprising:
a) a mounting plate having mounting holes; and
b) a camera housing made of plastic in the shape of a hollow truncated pyramid, having a front face forming an angle of between 95° and 135° with the mounting plate, the front face containing one or more openings, each opening containing a corresponding lens sealed within it; and
wherein said camera housing sealingly engages and is affixed to said mounting plate by fastening means.

17. The housing of claim 16, further comprising a gasket between said camera housing and said mounting plate.
